(19) United States
(12) Patent Application Publication
(10) Pub. No.: US 2002/0196855 A1
(43) Pub. Date: Dec. 26, 2002

(54) DVMPEG converter

(75) Inventors: Eiji Miyagoshi, Osaka (JP); Akihiro Watabe, Nara (JP); Takayuki Morishige, Kyoto (JP); Noboru Mizuguchi, Osaka (JP)

Correspondence Address: Jack Q. Lever, Jr., McDERMOTT, WILL & EMERY, 600 Thirteenth Street, N.W., Washington, DC, 20005-3096, US

(73) Assignee: Matsushita Electric Industrial Co., Ltd.

(21) Appl. No.: 10/139,336

(22) Filed: May 7, 2002

(30) Foreign Application Priority Data
May 29, 2001 (JP) 2001-159914

(51) Int. Cl. H04N 7/12

(52) U.S. Cl. 375/240.24; 370/365; 348/441

(57) ABSTRACT

An external memory interface in a DVMPEG converter inputs/outputs DV data, which has been decoded by a DV decoder, to/from an external memory. Moreover, a format converter receives data, which is read out from the external memory via the external memory interface, and converts the format thereof from a DV format to an MPEG format. Then, an MPEG encoder encodes the DV data whose format has been converted so as to produce MPEG data. Thus, it is possible to provide a DVMPEG converter having a small circuit scale.

### BACKGROUND OF THE INVENTION

The present invention relates to a DVMPEG converter for converting DV data into MPEG data.

In recent years, as various compression schemes for digital video data of DVC, MPEG, etc., become widespread, various types of media are provided and used in digital formats. However, DVCs for camcorders use a DV format, whereas storage media such as DVDs use a different compression scheme, i.e., an MPEG format. Therefore, there are problems in the art with regard to the conversion between these data formats.

In a conventional DVMPEG converter, DV data encoded in the DV format is input to a DV decoder so as to decode the DV data. Since the data is decoded while being shuffled, the decoded data is written to a shuffling memory for a deshuffling operation. The data format used in the shuffling memory is a format called “4:1:1”. The designation chiefly indicates position(s) at which chroma data is sampled. The data format will not be discussed herein, as it is explained in detail in “Specifications of Consumer-Use Digital VCRs using 6.3 mm magnetic tape”.

Then, when reading the deshuffled data from the shuffling memory, the data format is converted from 4:1:1 to 4:2:2. The 4:2:2 data format is the basic format used when converting a normal NTSC signal into a digital signal.

Then, the data, which has been converted into the 4:2:2 data format, is input to an MPEG2 encoder for an encoding operation. Herein, the MPEG2 encoding operation is an encoding operation based on the MPEG2 format whose data format is 4:2:0. Accordingly, the MPEG2 encoder first converts the 4:2:2 data format to the 4:2:0 data format, and then performs the MPEG2 encoding operation to produce MPEG2 data. The conventional DVMPEG converter converts DV data into MPEG2 data as described above.

However, with the prior art as described above, it is necessary to provide a buffer memory in the DVMPEG converter for the deshuffling operation and the MPEG2 encoding operation. In addition, the DV format is once converted to the 4:2:2 data format by using a converter, and then the data is encoded by using the MPEG2 encoder. This complicates the circuit configuration and increases the circuit scale.

### SUMMARY OF THE INVENTION

An object of the present invention is to provide a DVMPEG converter having a small circuit scale, by reducing the amount of buffer memory and circuits required for data format conversion.

Specifically, a DVMPEG converter of the present invention is a DVMPEG converter for converting DV data encoded in a DV format into MPEG data encoded in an MPEG format, the DVMPEG converter including: a DV decoder for decoding input DV data; an external memory interface for inputting/outputting the DV data, which has been decoded by the DV decoder, to/from an external memory; a format converter for receiving the decoded DV data, which is read out from the external memory via the external memory interface, and converting the format of the decoded DV data from the DV format to the MPEG format; and an MPEG encoder for encoding the DV data, whose format has been converted by the format converter, so as to produce MPEG data.

According to the present invention, the external memory interface allows the external memory to be used as a buffer memory for the decoded DV data. Thus, it is possible to provide a DVMPEG converter having a small circuit scale.

In the DVMPEG converter of the present invention as described above, it is preferred that the external memory interface performs a deshuffling operation on the decoded DV data when the DV data is input or when the DV data is output.

Moreover, in the DVMPEG converter of the present invention as described above, it is preferred that the format converter performs the format conversion by blocks.

Moreover, in the DVMPEG converter of the present invention as described above, it is preferred that the format converter converts the DV format directly to the MPEG format without an intermediate conversion to any other format.

Moreover, in the DVMPEG converter of the present invention as described above, it is preferred that the external memory interface inputs/outputs data, which is needed to be stored for reordering by the MPEG encoder, to/from the external memory.

### BRIEF DESCRIPTION OF THE DRAWINGS

FIG. 1 is a block diagram illustrating a configuration of a DVMPEG converter according to an embodiment of the present invention.

FIG. 2 is a schematic diagram illustrating the 4:1:1 data format.

FIG. 3 is a schematic diagram illustrating the 4:2:0 data format.

FIG. 4 is a schematic diagram illustrating a pixel position relationship between chroma data in the DV format (4:1:1) and that in the MPEG2 format (4:2:2).

FIG. 5 is a schematic diagram illustrating the reordering technique used in MPEG2 encoding.

### DETAILED DESCRIPTION OF THE INVENTION

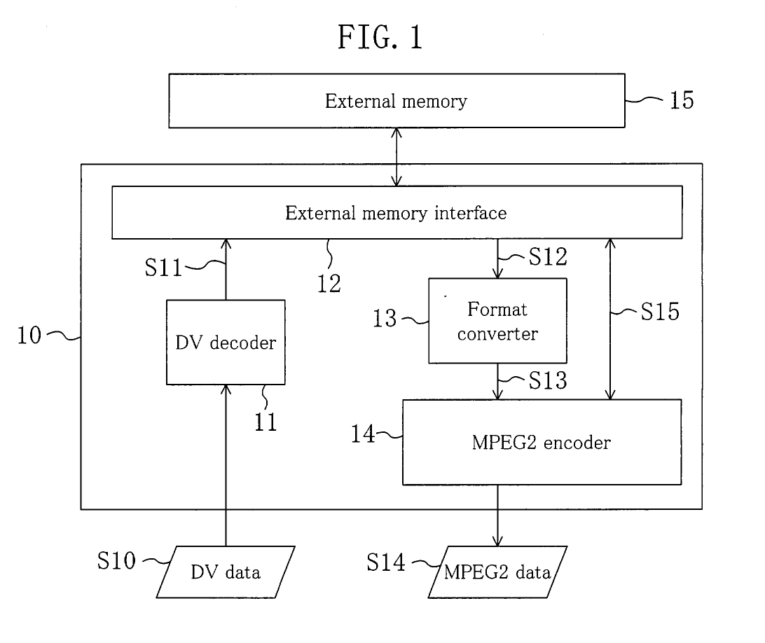

An embodiment of the present invention will now be described with reference to FIG. 1 to FIG. 5.

FIG. 1 is a diagram illustrating a configuration of a DVMPEG converter 10 according to the embodiment of the present invention. The DVMPEG converter 10 of FIG. 1 is a device for converting DV data S10 encoded in the DV format into MPEG2 data S14 encoded in the MPEG2 format, and includes a DV decoder 11, an external memory interface 12, a format converter 13, and an MPEG2 encoder 14 as an MPEG encoder. An external memory 15 is provided outside the DVMPEG converter 10.

The DV decoder 11 is a component for decoding the input DV data S10, and outputting the decoded DV data S11 to the external memory interface 12.

The external memory interface 12 is a component for controlling input/output of data to/from the external memory 15.

The format converter 13 is a component for converting the data format of data S12, which is input from the external memory interface 12, from the DV format (4:1:1) to the MPEG2 format (4:2:0).

The MPEG2 encoder 14 is a component for encoding data S13 whose format has been converted by the format converter 13, and outputting the MPEG2 data S14.

The external memory 15 is a buffer memory having a memory area for storing data that is received via the external memory interface 12.

An operation of the DVMPEG converter 10 of the present embodiment having such a configuration will now be described referring to the drawings as necessary.

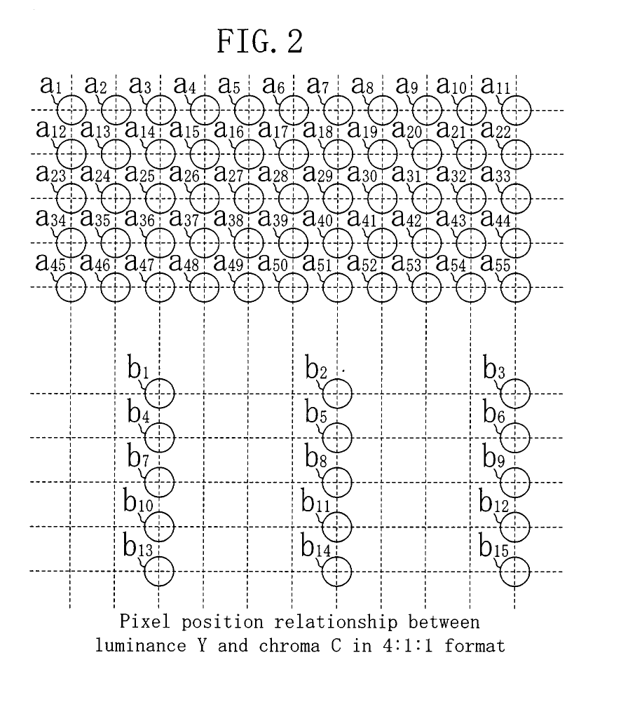

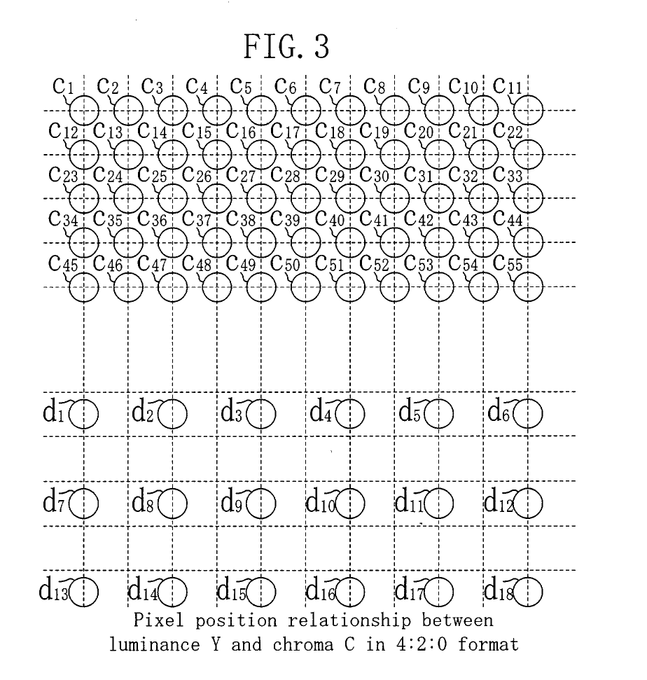

As an introduction, a data format called “4:1:1” (DV format) and a data format called “4:2:0” (MPEG2 format) will be briefly described with reference to FIG. 2 and FIG. 3.

FIG. 2 is a diagram illustrating the 4:1:1 data format. As illustrated in FIG. 2, in the 4:1:1 data format, luminance Y is located at pixel positions a₁ to a₅₅ while chroma C is located at pixel positions b₁ to b₅. Thus, in this data format, chroma C is subsampled to ¼ (i.e., every set of four pixels is thinned to one pixel) with respect to luminance Y in the horizontal direction.

FIG. 3 is a diagram illustrating the 4:2:0 data format. As illustrated in FIG. 3, in the 4:2:0 data format, luminance Y is located at pixel positions C₁ to C₅₅ while chroma C is located at pixel positions d₁ to d₁₈. Thus, in this data format, chroma C is subsampled to ½ (i.e., every set of two pixels is thinned to one pixel) with respect to luminance Y in the horizontal direction and in the vertical direction. Incidentally, there is another 4:2:0 data format used in MPEG1, in which the position of chroma C is horizontally shifted to the right by one half of a pixel from that in the above-described 4:2:0 data format used in MPEG2.

Therefore, as can be seen from a comparison between FIG. 2 and FIG. 3, the only difference between the 4:1:1 data format and the 4:2:0 data format is the position where chroma C is sampled.

Having discussed the difference between these data formats, the operation of the DVMPEG converter 10 of the present embodiment will now be described.

First, the DV data S10 encoded in the DV format is input to the DV decoder 11.

Then, the DV decoder 11 decodes the input DV data S10 in the 4:1:1 data format.

Then, the decoded DV data S11 is deshuffled. Specifically, the DV data S10 input to the DV decoder 11 has been encoded while being shuffled, i.e., data for each frame is rearranged according to a certain rule, in order to make the amount of bits to be generated uniform. Therefore, in order to produce an image frame in the DV format (4:1:1), it is necessary to perform a deshuffling operation of rearranging, again, the DV data S11, which has been decoded while being shuffled.

The decoded DV data S11 is deshuffled by the external memory interface 12. Herein, the deshuffling operation is performed when the decoded DV data S11 is input to the external memory 15 or when it is output from the external memory 15. Thus, the deshuffling operation is performed by using the external memory 15, thereby eliminating the need for a dedicated buffer memory for performing the deshuffling operation, and thus reducing the circuit scale of the DVMPEG converter 10 of the present embodiment.

Note that the deshuffling operation can be performed at one of two timings, i.e., when the data is input and when the data is output. In the present invention, the deshuffling operation may be performed at either one of the two timings.

Then, the format of deshuffled data S12, which is input from the external memory interface 12, is converted by the format converter 13 from the DV format to the MPEG2 format. Herein, the DV format (4:1:1) is converted directly to the MPEG2 format (4:2:0) without the intermediate conversion to the 4:2:2 data format, which is the basic format of an NTSC signal.

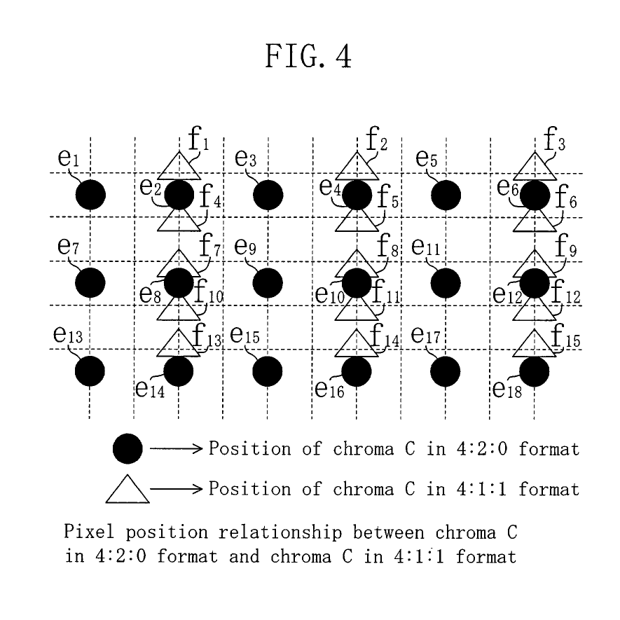

The operation will now be described in detail with reference to FIG. 4. FIG. 4 is a schematic diagram illustrating a pixel position relationship between chroma C in the MPEG2 format (4:2:2) and that in the DV format (4:1:1). Referring to FIG. 4, chroma C in the 4:2:0 data format is located at pixel positions e₁ to e₈ while chroma C in the 4:1:1 data format is located at pixel positions f₁ to f₁₅. As can be seen from FIG. 4, the simplest way to realize such a conversion is to use a filter with two horizontal taps and two vertical taps. Specifically, chroma C at the pixel position e₂ in the MPEG2 format (4:2:0) can be obtained by adding together chroma C at the pixel position f₁ and chroma C at the pixel position f₄ in the DV format (4:1:1), and then dividing the sum by two. As described above, the conversion from the DV format (4:1:1) to the MPEG2 format (4:2:0) can be easily realized by using a very simple filter. Moreover, the direct conversion from the DV format (4:1:1) to the MPEG2 format (4:2:0) eliminates the need for temporarily storing data of the 4:2:2 data format, thus reducing the amount of buffer memory. In fact, a data amount comparison between the 4:1:1 data format and the 4:2:2 data format shows that an NTSC signal for one frame is equal to 5.529600 Mbits in the 4:2:2 data format and 4.141200 Mbits in the 4:1:1 data format, indicating that there is a difference of 1.388400 Mbits therebetween. This is a significant reduction in the amount of buffer memory.

Herein, since the MPEG2 encoder 14 processes data by macroblocks, the format converter 13 performs the format conversion operation also by macroblocks.

Therefore, the format converter 13 can perform the vertical filtering operation by blocks, whereby the format converter 13 is required to have only a block memory for 64 pixels. Thus, the format converter 13 is not required to have a line memory for 180 pixels in the raster direction, thereby reducing the amount of buffer memory in the format converter 13 by about ⅓.

Note that “180 pixels” as used herein is the number of pixels in each horizontal line at which chroma C is sampled in the 4:1:1 data format, and “a block memory for 64 pixels” as used herein is an amount of buffer memory for a number of pixels (4 pixels×16 lines) in each macroblock at which chroma C is sampled in the 4:1:1 data format, among all pixels (16 pixels×16 lines) in each macroblock.

After the data format conversion operation, the MPEG2 encoder 14 performs a normal MPEG2 encoding operation on the data S13, which has been converted to the MPEG2 format, so as to output the MPEG2 data S14. A normal MPEG2 encoding operation requires a buffer memory for reordering and/or Video Bit Buffer (VBB). In the present invention, however, the external memory 15 can be used also as a buffer memory for operations such as reordering via arbitration by the external memory interface 12.

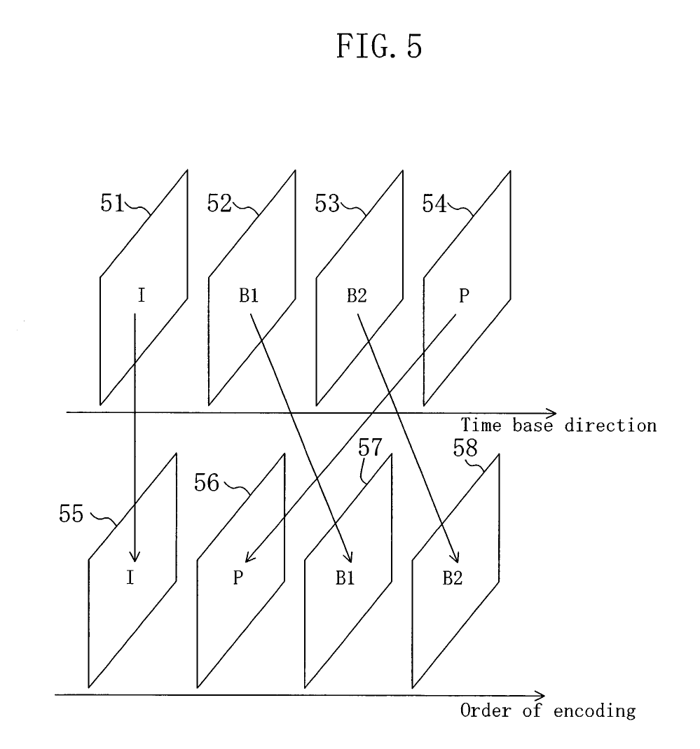

FIG. 5 is a schematic diagram illustrating the reordering technique used in MPEG2 encoding. It is assumed that the image data is input in the order of a frame 51 (I picture), a frame 52 (B1 picture), a frame 53 (B2 picture), and then a frame 54 (P picture), as illustrated in the upper half of FIG. 5. The image data is actually encoded in the order as illustrated in the lower half of FIG. 5. First, the frame 51 is encoded into a frame 55. Then, the frame 54, which is subsequent in time to the frames 52 and 53, is encoded into a frame 56, because it is necessary to perform bidirectional prediction for the frames 52 and 53. Then, the frames 52 and 53 are encoded in this order into frames 57 and 58, respectively, through bidirectional prediction using the frames 51 and 54. Therefore, in the case of FIG. 5, a memory is required for storing frame data S15 for at least the frames 52 and 53. In the present invention, however, the frame data S15 can be stored in the external memory 15 via the external memory interface 12. Since the external memory 15 is used also as a buffer memory for reordering as described above, the amount of buffer memory in the MPEG2 encoder 14 can be reduced.

Note that while the external memory 15 is provided outside the DVMPEG converter 10 in the embodiment described above, the present invention can be carried out also in a case where the external memory 15 is provided in the DVMPEG converter 10.

As described above, the DVMPEG converter 10 of the present embodiment includes the external memory interface 12 for controlling input/output of data to/from the external memory 15, thereby allowing the external memory 15 to be used commonly as a buffer memory for the deshuffling operation and as a buffer memory for the encoding operation by the MPEG2 encoder 14. Moreover, the DVMPEG converter 10 includes the format converter 13, whereby the DV format (4:1:1) is converted directly to the MPEG2 format (4:2:0) without an intermediate conversion to any other data format. Thus, it is possible to reduce the amount of buffer memory and circuits required for data format conversion, and to provide the DVMPEG converter 10 having a simplified circuit configuration and a reduced circuit scale.

What is claimed is:

1. A DVMPEG converter for converting DV data encoded in a DV format into MPEG data encoded in an MPEG format, the DVMPEG converter comprising:
a DV decoder for decoding input DV data;
an external memory interface for inputting/outputting the DV data, which has been decoded by the DV decoder, to/from an external memory;
a format converter for receiving the decoded DV data, which is read out from the external memory via the external memory interface, and converting the format of the decoded DV data from the DV format to the MPEG format; and
an MPEG encoder for encoding the DV data, whose format has been converted by the format converter, so as to produce MPEG data.

2. The DVMPEG converter of claim 1, wherein the external memory interface performs a deshuffling operation on the decoded DV data when the DV data is input or when the DV data is output.

3. The DVMPEG converter of claim 1, wherein the format converter performs the format conversion by blocks.

4. The DVMPEG converter of claim 1, wherein the format converter converts the DV format directly to the MPEG format without an intermediate conversion to any other format.

5. The DVMPEG converter of claim 1, wherein the external memory interface inputs/outputs data, which is needed to be stored for reordering by the MPEG encoder, to/from the external memory.
